(19) United States
(12) Patent Application Publication
(10) Pub. No.: US 2004/0130636 A1
(43) Pub. Date: Jul. 8, 2004

(54) Electronic image intent attribute

(76) Inventors: Charles E. Schinner, Windsor, CO (US); David J. Staudacher, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/338,064

(22) Filed: Jan. 6, 2003

(51) Int. Cl. H04N 5/262

(52) U.S. Cl. 348/239; 348/222.1

(57) ABSTRACT

A method of managing electronic images in an electronic imaging device includes capturing an electronic image and associating an intent attribute with the electronic image. The intent attribute directs actions to be performed with the electronic image.

### BACKGROUND

Electronic imaging devices such as digital cameras are used in a wide range of applications and are steadily becoming less expensive and simpler to use. Image quality is now limited more by output devices than by the electronic imaging devices, and electronic images may be stored indefinitely without the image degradation suffered by film-based images. Electronic imaging devices generate images that can be viewed immediately and used in a variety of ways such as printing, posting to a web page on the World Wide Web, transmitting to others by electronic mail (email) or other means, etc. They can also rapidly capture large numbers of images which can be previewed and stored or deleted as desired. As the capacity of removable solid-state memories has increased and price has gone down, typical electronic imaging devices can now capture and internally store hundreds of electronic images.

Managing the large number of images captured by electronic imaging devices is becoming increasingly difficult as memory capacity has increased. Typically, electronic imaging devices automatically name the image files as they are stored, using esoteric naming schemes such as a letter followed by a number that is incremented with each image (e.g., “P0000142.jpg”). Thus, a user may be forced to search through hundreds of images with no descriptive names in order to locate a particular image. In an effort to overcome this difficulty, desktop computers connected to the electronic imaging devices are often provided with software applications which form miniature versions, called thumbnails, of the images to enable the user to locate images. The user may then perform tasks with the images using the graphical thumbnail display on a desktop computer connected to the electronic imaging device, such as copying, renaming, transmitting, emailing, etc.

However, often the user has some idea or intent of what to do with an image when it is captured, but there are limited mechanisms in existing electronic imaging device to take this intent into account or to note it for later use.

### SUMMARY

An intent attribute is entered or selected and associated with images in an electronic imaging device. The intent attribute directs actions to be performed with the associated image, such as where the image will be stored on connected devices, who may access the image, when the image will be deleted, etc. The intent attributes may be entered in a variety of manners, such as manually entering them through a user interface on the electronic imaging device or selecting them from a list, etc. Lists of intent attributes may be pre-populated by the manufacturer, edited on a computer connected to the electronic imaging device, dynamically expanded by automatically detecting available destinations for images, etc.

### BRIEF DESCRIPTION OF THE DRAWING

Illustrative embodiments of the invention are shown in the accompanying drawing, in which:

FIG. 1 is an isometric front view illustration of an exemplary embodiment of an electronic imaging device which may employ intent attributes;

FIG. 2 is an isometric rear view illustration of the exemplary embodiment of the electronic imaging device of FIG. 1;

FIG. 3 is a block diagram of an exemplary embodiment of an electronic imaging device connected to a computer;

FIG. 4 is an illustration of an exemplary embodiment of an electronic imaging device connected to a computer by a cable;

FIG. 5 is an illustration of an exemplary embodiment of an electronic imaging device connected to the Internet by a wireless connection;

FIG. 6 is an illustration of an exemplary embodiment of an electronic imaging device connected to a media server by a wireless connection;

FIG. 7 is a flowchart summarizing an exemplary use of intent attributes in an electronic imaging device.

### DESCRIPTION

The drawing and description, in general, disclose an electronic imaging device which enables intent attributes to be selected or created and associated with one or more electronic images. The intent attributes may be used to identify locations or devices to which electronic images are to be moved or copied, users who are authorized to access images, or simply to better identify electronic images as they are captured by the electronic imaging device, among other uses. This helps the user to identify images after they are captured and to keep track of the user's intent for the images. For example, even if the same electronic imaging device is used to capture images of multiple events such as a vacation or graduation, the image files are still generally stored in the same directory of the electronic imaging device with the same esoteric filename format. The user may add intent attributes to each image or to groups of images to identify them. This attribute may later be used either by the electronic imaging device or by other devices which access the images to direct actions such as how and where to move the images, when images will be erased, and who may access them.

Any type of electronic imaging device may be adapted to employ intent attributes. Although electronic image intent attributes will be described herein with respect to a digital camera, it is important to note that they are not limited to use with any particular type of imaging device. For example, the electronic imaging device may alternatively comprise a video camera, a scanner, a personal digital assistant (PDA), etc. Before describing electronic image intent attributes in detail, an exemplary digital camera which may employ intent attributes will be described.

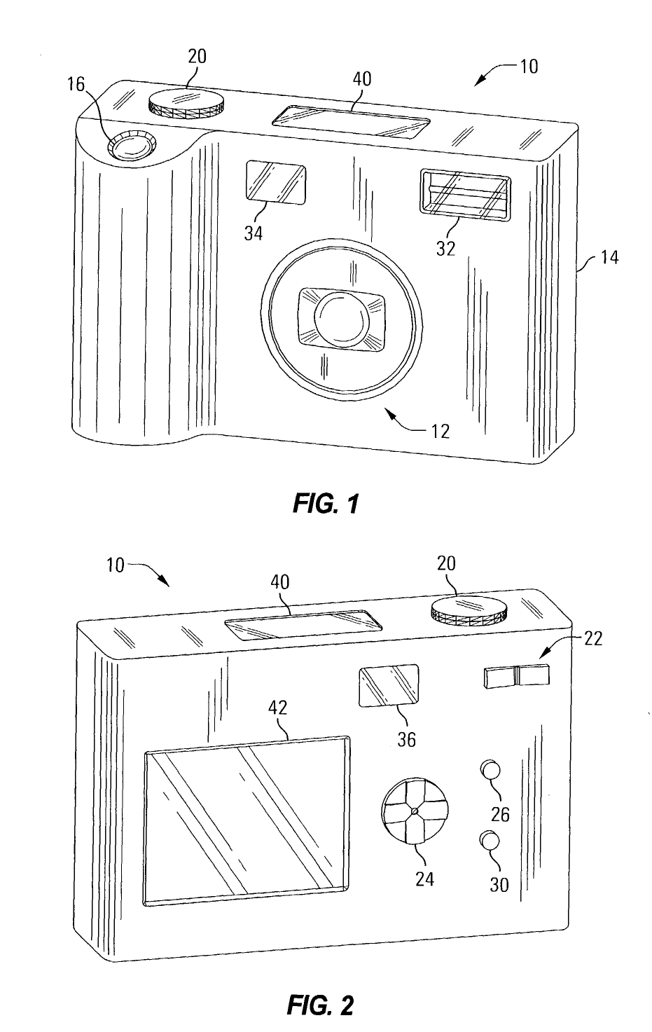

Referring now to FIGS. 1 through 3, an exemplary digital camera 10 comprises a housing portion or body 14 which is sized to receive the various systems and components required by the digital camera 10. For example, in the embodiment shown and described herein, the body 14 is sized to receive a lens assembly 12, a photodetector 60, an image processing system 66 to process and format the image data captured by the photodetector 60, and a solid-state storage device 72 to store the image data. The lens assembly 12 is located in the body 14 to allow light to enter the digital camera 10 and to focus it on the photodetector 60.

The digital camera 10 may include a processor 62 for controlling the operation of the digital camera 10 and for performing any needed tasks. The processor 62 may comprise one or more general purpose processors, and may be dedicated to a single task in the digital camera 10 or may be shared for multiple tasks. Alternatively, the processor 62 may comprise one or more application specific integrated circuits (ASICs) or other task-specific processors. The digital camera 10 may include an internal memory 64 to provide temporary storage during image processing operations, to act as a buffer during image capture operations, or to aid in any other operations that require internal storage space. The various components of the digital camera 10 (e.g., 62, 64, etc.) may be connected by a bus 76. The digital camera 10 may also include a user interface 70 to provide and process menus, process button input, communicate with external devices, etc. Note that the term user interface as used herein is not limited to processing menus or buttons or other communication directly with a user, but may perform other tasks in the digital camera 10 such as interfacing with connected devices, handling intent attributes, etc.

Please note that the exemplary digital camera 10 is not limited to the elements described herein or to the configuration described herein. For example, the image processing system 66 and user interface 70 may be separate components in the digital camera 10, or may consist of firmware stored in one or more read-only memories (ROMS) that is executed by a processor 62. As the electronic imaging device is not limited to a digital camera 10, so the exemplary digital camera 10 is not limited to any particular configuration to provide the benefits of electronic image intent attributes.

Control buttons such as a shutter control button 16, a mode dial 20, a zoom control switch 22, and others (e.g., 24, and 26) as needed are provided on the outside of the body 14. For example, the digital camera 10 may include a button 30 to trigger entry or selection of intent attributes for electronic images.

The digital camera 10 may include an illumination system such as a flash 32 mounted on the outside of the body 14. Viewfinder windows 34 and 36 and display devices 40 and 42 are also located on the outside of the body 14. The foregoing systems and devices will now be described in more detail.

The image data captured by the photodetector 60 may be buffered and processed in the internal memory 64 and stored in the solid-state storage device 72 in the digital camera 10. The solid-state storage device 72 may comprise any suitable type of memory, such as a removable rewriteable non-volatile memory, random access memory (RAM), write-once memories, or any other solid state storage medium. For example, the solid-state storage device 72 in the exemplary digital camera 10 may comprise a Compact Flash or SmartMedia memory card. (Note that intent attributes are not limited to use with electronic imaging devices with solid-state memories, such as the exemplary digital camera 10 described herein.)

The image processing system 66 processes and formats the image data, either before or after storage in the solid-state storage device 72. As discussed above, the image processing system 66 may comprise any suitable device such as a microprocessor and computer-executable instructions in an associated memory, or a hard-coded device such as an ASIC. The image processing system 66 processes image data to scale images for display on a graphical display device 42, among other tasks. The graphical display device 42 comprises a liquid crystal display (LCD) or any other suitable display device. An alphanumeric display device 40 on the digital camera 10 also comprises an LCD or any other suitable display device, and is used to indicate status information, such as the number of images which can be captured and stored in the storage device 84, and the current mode of the digital camera 10.

The user interface 70 may also be implemented using any suitable device such as a microprocessor and computer-executable instructions in an associated memory, or a hard-coded device such as an ASIC. The user interface 70 may process input from the buttons (e.g., 16) on the digital camera 10, communicate with external devices, and provide menus and other aids to the user. In particular, the user interface 70 enables the user to select or enter intent attributes for one or more electronic images in the digital camera 10, and may enable selection of methods to perform actions with images based on their intent attributes, as will be described in more detail below.

The digital camera 10 may also include other components, such as an audio system. However, digital cameras are well-known in the art and could be adapted to employ intent attributes by persons having ordinary skill in the art after having become familiar with the teachings of the present invention. Therefore, the components of the digital camera 10 utilized in one embodiment of the present invention, as well as the various ancillary systems and devices that may be utilized in one embodiment of the present invention, will not be described in further detail herein.

Now that an exemplary digital camera 10 that may capture electronic images has been described, the intent attribute associated with images will now be described in more detail. The intent attribute is associated with an image to indicate the user's intent about anything to be done with the image in the future—what it will be named, where it will go, who can access it, when it will be erased, etc. The intent attribute enables the user to identify the image and direct future actions to be taken with it as it is captured, rather than forcing the user to later wade through a large number of generically-named image files to locate a desired file and then try to remember if anything in particular was to be done with the image file. Actions may be automatically performed later if desired based on the intent attributes, such as moving the image files to predetermined locations on a connected computer, sending images by electronic mail, archiving to relatively permanent storage media such as optical discs, and so on.

One or more intent attributes may be associated with each image or with groups of images. Intent attributes may be associated with images in any desired manner. For example, intent attributes may be entered or selected by the user for each image, or may be selected as default intent attributes for subsequently captured images. Several exemplary methods of associating intent attributes with images will be described below.

The intent attribute association process may be initiated in any desired manner. For example, it may be initiated automatically after each image is captured, or by the user pressing a dedicated hardware button (e.g., 30) on the digital camera 10, or by activating a method in the user interface 70 by selecting a menu item displayed on the graphical display device 42, or it may be initiated using a voice recognition system.

In another embodiment, the intent attribute association process may be initiated automatically by an image analysis algorithm, in which subjects are recognized and grouped with common intent attributes. For example, a subject's face may be recognized in multiple images, and the images may be automatically associated with intent attributes to store the images in a common location.

Intent attributes may also be selected as default attributes for subsequently captured images, as described above. The digital camera 10 may offer a number of these different options and may apply them based on the imaging device configuration, such as the setting of the mode dial 20 or settings selected in menus displayed on the graphical display device 42.

In one exemplary method of associating intent attributes with images, intent attributes are selected from pre-populated lists of available intent attributes. In this exemplary method, the camera manufacturer programs the digital camera 10 with lists of intent attributes that would be useful to most users. For example, a pre-populated list of intent attributes may contain items such as ‘Vacation images’, ‘Birthday’, ‘Favorite’, ‘Store on compact disc’, ‘Erase after transferred to computer’, etc. The list of intent attributes may be displayed on the digital camera 10, for example on the graphical display panel 42, so that the user can scroll through the list and select intent attributes using buttons (e.g., 24 and 26) on the digital camera 10. Multiple intent attributes may be selected from the list and associated with an image. For example, as the user scrolls through the list of intent attributes, a button (e.g., 26) on the digital camera 10 may be used to mark one or more intent attributes as selected. The selected intent attributes may then be applied to the image.

In another exemplary method of associating intent attributes with images, intent attributes are selected from lists of available intent attributes, and the lists may be edited on a connected computer and transmitted to the digital camera 10. This enables the user to add intent attributes to the list that are more relevant to the user. In this case, lists of available intent attributes may best be stored in a non-volatile memory in the digital camera 10, and in a location that will not likely be erased accidentally.

In another exemplary method of associating intent attributes with images, intent attributes are selected from lists of available intent attributes, and the lists are dynamically expanded by automatically detecting potential destinations for images and adding those destinations to the list of intent attributes. The list of intent attributes may further be dynamically expanded by noting details when actions are manually performed with images, such as email addresses to which images are transmitted, and adding those details to the list.

In another exemplary method of associating intent attributes with images, intent attributes are manually entered by an alphanumeric entry mechanism in the user interface 70. For example, an alphabet may be displayed on the graphical display panel 42 and buttons (e.g., 24 and 26) on the digital camera 10 may be used to navigate through the alphabet to enter intent attributes for one or more images.

Intent attributes may be selected or entered for the most recently captured image, or a method may be provided in the user interface 70 to select one or more previously captured images and associate one or more intent attributes with the selected images. For example, as the user browses through thumbnails (miniature views) of the images stored in the digital camera 10, a button (e.g., 26) on the digital camera 10 may be used to mark or unmark one or more images as selected. One or more intent attributes may then be selected or entered and applied to the selected images.

Intent attributes may be stored in the digital camera 10 in a variety of manners, either embedded in image files or separately with some type of link to the appropriate image files. For example, intent attributes may be embedded in the image files as information tags, as described in the EXIF specification, the Digital Still Camera Imaqe File Format Standard (Exchangeable image file format for Diqital Still Cameras: Exif) Version 2.1, Jun. 12, 1998, Japan Electronic Industry Development Association. Alternatively, intent attributes may be stored outside of the image files with links or pointers between image files and intent attribute files, or a database may be configured to associate intent attributes with image files, etc.

Intent attributes may be transferred from the digital camera with the associated image files, or the intent attributes may be read, erased, and acted upon. For example, if the intent attribute for a given image specifies that the image is to be emailed to a specified address, the intent attribute may be read to determine the email address, erased from the image file, and the image file may be emailed without the intent attribute. Alternatively, an image file may be transferred with the intent attribute intact for future reference and use by other devices having access to the image file. For example, the intent attribute may indicate who is authorized to access the image file. When the image file is transferred to a computer connected to the digital camera 10, the intent attribute may be left embedded in the image file so that the computer can enforce the security provisions specified by the intent attribute.

The digital camera 10 and connected devices may use the intent attributes associated with the image files to direct actions taken with the image files. The devices may read the intent attributes from time to time, such as when they are powered on, when they are connected to other devices, or at regular intervals. The intent attributes may trigger actions, such as to erase an image after a certain date, or may direct images, such as routing images to certain locations during a copy operation.

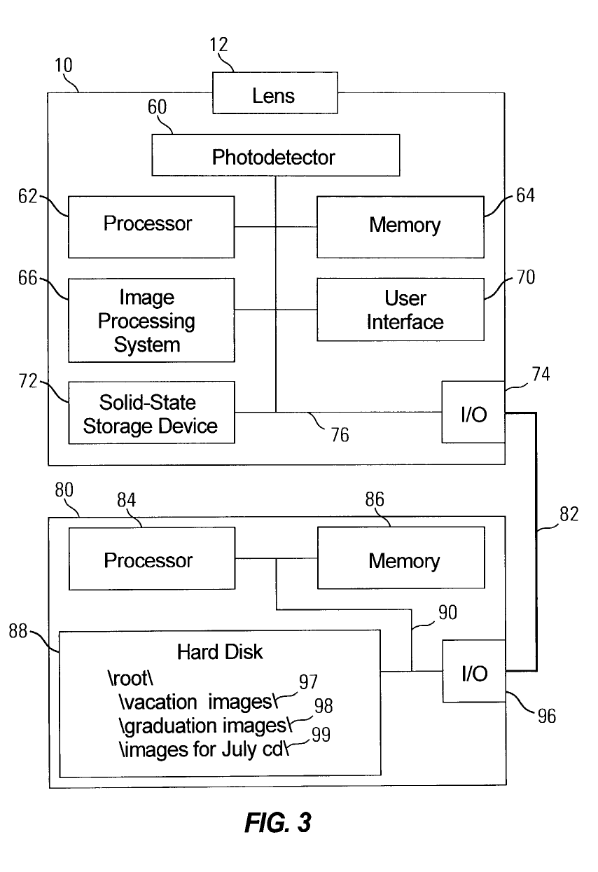

The digital camera 10 may be connected in any suitable manner to various external devices, to which images may be transferred. Exemplary connections and external devices are illustrated in FIGS. 3-6. However, it is important to note that the external devices and the types of connections are purely exemplary, and the use of intent attributes is not limited to the external devices and types of connections shown herein.

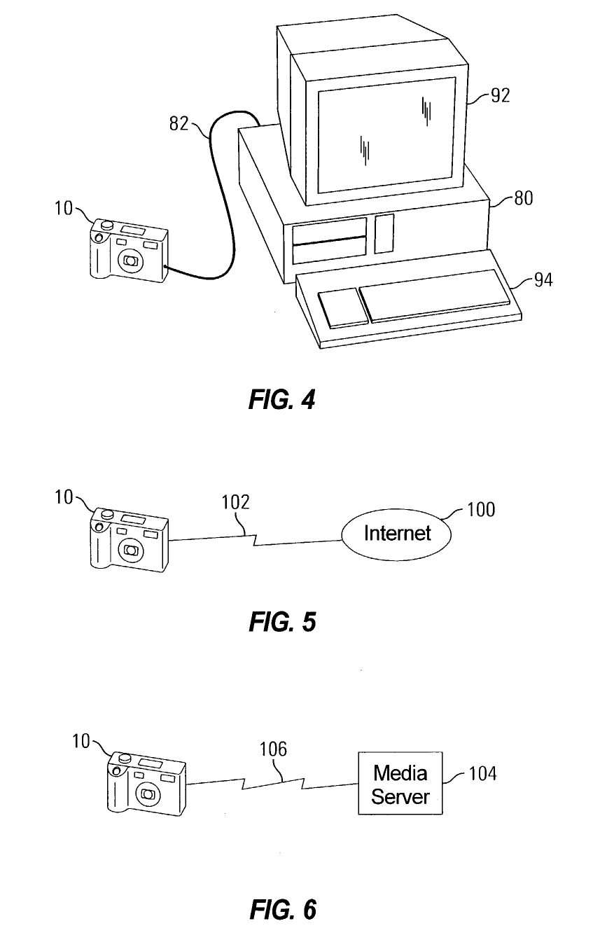

Referring now to FIGS. 3 and 4, an exemplary computer 80 to which the digital camera 10 may be connected may comprise a processor 84, memory 86, hard disk 88, and other internal components linked by a bus 90. The computer 80 may also comprise a monitor 92, keyboard 94, and other components as is well known. The digital camera 10 may be connected to the computer 80 by a cable 82 attached to Input/Output (I/O) components 74 and 96 in the digital camera 10 and computer 80.

Intent attributes may be used to direct automatic or manual actions performed on the images while the digital camera 10 is connected to the computer 80 and in the computer 80 after the digital camera 10 is disconnected. For example, images may be copied to particular locations or directories in the computer 80 based on the intent attributes, such as to a directory 97 for images of a vacation, or another directory 98 for images of a graduation. The intent attributes may directly specify locations in the computer 80, or may be mapped indirectly in the computer 80 to directories (e.g., 97 and 98) based on the intent attributes. The intent attributes may also indicate that the associated image files should be included in a set of files that will be copied to a particular piece of media. For example, images may be marked with an intent attribute causing them to be included with images to be stored on an optical disc 99 such as a CD-R or a DVD+RW.

Referring now to FIG. 5, the digital camera 10 may also be connected to networks such as the Internet 100 by any suitable connection such as a wireless radio-frequency (RF) link 102. The digital camera 10 may then check the intent attributes of images on the camera 10 to see if actions should be performed, such as transmitting images to an archive on the World Wide Web, posting images on a web page, or sending images via email to various recipients. As discussed above, the actions may be triggered manually or automatically when the digital camera 10 is connected to the Internet 100.

Referring now to FIG. 6, the digital camera 10 may also be connected to a media server 104 by any suitable connection such as a wireless local area network (LAN) 106. The digital camera 10 may then check the intent attributes of images on the camera 10 to see if any images should be stored on the media server 104.

Note that, as described above, if the intent attributes are transferred with image files, devices other that the digital camera 10 may perform actions based on the intent attributes. This means that the action may be independent of the actual communication channel used from the digital camera 10. For example, image files may be copied directly from the digital camera 10 to slave peripherals, or they may be exchanged between the digital camera 10 and other devices on a peer-to-peer basis, or they may be routed with the help of a computer 80 in order to perform the actions required by the intent attributes, or they may be transferred from the digital camera 10 via a removable memory card.

Again, the intent attribute is associated with an image to indicate the users intent about anything to be done with the image in the future. The following are some examples of intent attributes:

copy to directory “vacation images” on computer

move to hard-disk based media server

include in set of files to write to “images for July CD”

email to user@home.net

erase after Jun. 1 2004

private

access code ####

Note that intent attributes are not limited to any particular type of action. The first four exemplary intent attributes deal with placing images in various locations, either copying them to directories in a connected computer, moving them to other storage devices, including them in a set of files for a particular archive, or transmitting them via email to given addresses, independent of the actual communication channel used. Dates or date ranges may be included, as illustrated by the ‘erase after’ intent attribute above. Intent attributes may also indicate the users intent as to who may access images files, either the user only (‘private’) or anyone knowing an access code, etc. This list is not meant to be exhaustive, either in the specific intent attributes listed or the categories or types of intent attributes listed.

The digital camera 10 may be adapted to perform actions based on intent attributes, as well as selecting or entering intent attributes and associating them with image files. In one exemplary embodiment, this is accomplished by adding methods to the user interface 70 which may be selected through menus displayed on the graphic display panel 42. These methods may be programmed to perform any desired action on image files as directed by associated intent attributes. For example, a method may be added to search the solid-state storage device 72 or other memories, either on the digital camera 10 or on connected devices, to move image files after certain dates. Other methods may be added to locate image files by searching through stored image files for user-selectable intent attributes. That is, the method may search for all images files having a certain intent attribute.

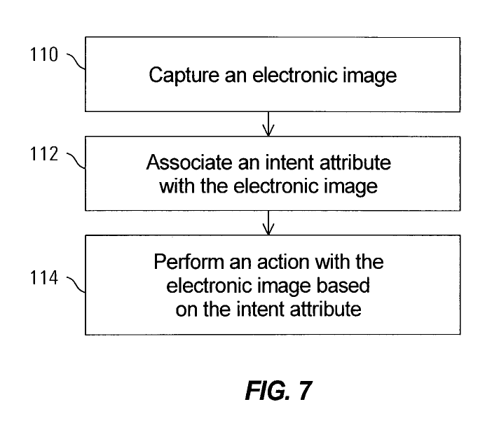

In summary, intent attributes may be used in an electronic imaging device to help manage electronic images by capturing 110 (FIG. 7) an electronic image, associating 112 an intent attribute with the electronic image, and performing 114 an action with the electronic image based on the intent attribute.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of managing electronic images in an electronic imaging device, comprising:
capturing an electronic image in said electronic imaging device; and
associating an intent attribute with said electronic image in said electronic imaging device, wherein said intent attribute directs actions to be performed with said electronic image.

2. The method of claim 1, wherein said intent attribute is associated with said electronic image by storing said intent attribute in an image file with said electronic image.

3. The method of claim 1, wherein said intent attribute comprises a location in which said electronic image will be placed.

4. The method of claim 3, wherein said location comprises a folder on a computer to be connected to said electronic imaging device.

5. The method of claim 3, wherein said location comprises an electronic mail address.

6. The method of claim 3, wherein said location comprises a device to be connected to said electronic imaging device.

7. The method of claim 3, wherein said location comprises an archive to be created with images from said electronic imaging device.

8. The method of claim 1, wherein said intent attribute comprises a time at which said electronic image will be deleted from said electronic imaging device.

9. The method of claim 1, wherein said intent attribute prevents unauthorized access to said electronic image.

10. The method of claim 1, further comprising performing an action with said electronic image based on said intent attribute.

11. The method of claim 10, wherein said action comprises transferring said electronic image to a location indicated by said intent attribute.

12. The method of claim 10, wherein said action comprises enabling access to said electronic image if security requirements in said intent attribute are satisfied.

13. The method of claim 10, wherein said action comprises locating at least one particular electronic image based on at least one intent attribute associated with said at least one particular electronic image.

14. The method of claim 1, further comprising entering said intent attribute using a user interface in said electronic imaging device.

15. The method of claim 1, further comprising selecting said intent attribute from a list of intent attributes.

16. The method of claim 15, wherein said list is pre-populated with intent attributes.

17. The method of claim 15, wherein said intent attributes are added to said list at least partly on a computer and transferred to said electronic imaging device.

18. The method of claim 15, wherein said list is at least partly dynamically expanded by adding said intent attributes.

19. The method of claim 18, wherein said list is dynamically expanded by automatically detecting locations to which images may be transferred from said electronic imaging device.

20. The method of claim 1, further comprising generating an intent attribute automatically by analyzing image content to determine at least one appropriate intent attribute.

21. An electronic imaging apparatus, comprising:
a memory in said electronic imaging apparatus for storing electronic images and for storing intent attributes associated with said electronic images, said intent attributes for directing actions to be performed with said electronic images; and
a user interface connected to said memory, said user interface including an intent attribute entry mechanism.

22. The electronic imaging apparatus of claim 21, further comprising an intent attribute entry trigger for initiating said intent attribute entry mechanism.

23. The electronic imaging apparatus of claim 22, wherein said intent attribute entry trigger comprises a button on said electronic imaging apparatus.

24. The electronic imaging apparatus of claim 22, wherein said intent attribute entry trigger comprises a method in said user interface.

25. The electronic imaging apparatus of claim 22, wherein said intent attribute entry trigger comprises a voice recognition system.

26. The electronic imaging apparatus of claim 21, said user interface further comprising computer executable instructions to provide a method for performing said actions with said electronic images based on said intent attributes.

27. The electronic imaging apparatus of claim 21, said user interface further comprising computer executable instructions to provide a method for locating certain images among said electronic images based on said intent attributes.

28. An electronic imaging apparatus, comprising:
means for storing at least one electronic image in said electronic imaging apparatus; and
means for associating an intent attribute with said at least one electronic image, wherein said intent attribute indicates at least one processing action intended to be performed with said at least one electronic image.
